(19) United States
(12) Patent Application Publication
(10) Pub. No.: US 2009/0047061 A1
(43) Pub. Date: Feb. 19, 2009

(54) MECHANISM ALLOWING A RELATIVE MOVEMENT BETWEEN TWO RIGID PARTS, BUT PROVIDED WITH ANTI-ROTATION MEANS

(76) Inventors: Richard Chene, Neuilly-sur-Seine (FR); Dominique Delamour, Les Menuls (FR); Alain Miklitarian, Paris (FR); Olivier Rodi, Gambais (FR)

Correspondence Address: YOUNG & THOMPSON, 209 Madison Street, Suite 500, ALEXANDRIA, VA, 22314, US

(21) Appl. No.: 12/090,954

(22) PCT Filed: Oct. 11, 2006
(86) PCT No.: PCT/FR2006/002278

§ 371 Date: Sep. 22, 2008

(30) Foreign Application Priority Data
Oct. 20, 2005 (FR) 05/10706

(51) Int. Cl. F16B 12/44

(52) U.S. Cl. 403/65

(57) ABSTRACT

A mechanism includes a hook (150) provided with a rectilinear shank (115) sliding in a housing (109) dependent on one (107) of the rigid elements and a co-operating part (103) dependent on the other (108) rigid element, and which is engaged in the recessed zone of the hook (150). At its end opposite the shank, the curved portion of the hook includes a rectilinear extension (152) parallel to the shank, and a sheath (153) is adapted to receive the extension, which is capable of a rectilinear translational movement parallel to the shank (115), while remaining permanently engaged in the sheath (153).

The subject of the present invention is a mechanism making it possible to attach two pieces together while allowing them to have, relative to one another, a certain pivoting capability, such a mechanism finding its application particularly in equipment used in robotics and in spectacle frames.

This mechanism may have no material rotation shaft, in which case reference will be made to articulation, or may comprise such a material rotation shaft, in which case reference will be made to a hinge.

More precisely, the invention relates to a mechanism of the aforementioned type arranged between an end of a first rigid element and an end of a second rigid element, the said ends having bearing surfaces capable of matching respectively with one another, elastic means being provided to maintain the contact between the said surfaces.

Most of the equipment used in robotics (walking robots, modular robots, manufacturing robotics, medical robotics, micro-robotics, etc.) are furnished with articulations allowing a pivoting movement over a continuous angular range and often in a multiplicity of planes. Such articulations allow the equipment to perform, in the reachable space, a large variety of actions and movements. However, the mechanisms of these articulations are by nature unstable, or mono-stable in the rest position, and it follows that these items of equipment constantly put a strain on their actuator (for example, a control cylinder) to keep them in a chosen position, when it is not their rest position.

Pivoting over a range may be neither necessary nor even desirable.

Thus, in medical robotics, the use over a continuous range of variable-vision optical systems is of no real interest to surgeons. Similarly, the clearances of poly-articulated endoscopes, as they are used in practice, are close to “all or nothing”.

In manufacturing robotics, the continuity of the pivoting range also impairs the precision and repetitivity of positioning over time.

As for walking robots, they do not necessarily need legs whose reachable space is continuous.

In short, the concept of discrete articulation would reduce costs, limit the strain on the actuator or actuators and, in the case of manufacturing robotics, would ensure precise positioning over time.

In the field of spectacle manufacture and other fields (opening parts on motor vehicles, glass doors on furniture, for example), use is sometimes made of hinges called “elastic hinges” suitable for holding the mobile portion in one or two stable positions, (like closed and open positions of a side arm of spectacles, for example).

These “elastic” hinges are, for the most part, furnished with a rotation shaft which limits the movement of the mobile portion to a movement in a given plane.

Also known, according to EP-A-0 886 712, are spectacle hinges whose mobile and fixed portions are connected via an elastic link, allowing a movement of the mobile portion in any plane between fixed limits: these hinges certainly have a seductive effect, but they are complex to manufacture and to miniaturize and their relative fragility is sorely tested by the wearers who tend to play with the side arms. These hinges are not suited to keeping themselves in several stable positions in several planes and/or to being furnished with an actuator device which would make it possible to move from one stable position to another.

FR-A-2 850 143 proposed an articulation capable of allowing two rigid elements (fixed and mobile respectively) to occupy various stable and/or unstable relative angular positions, the end of the mobile element away from the articulation moving along repetitive linear trajectories, without it being necessary to put a strain on any actuator device with which the articulation may be furnished.

For this purpose, FR-A-2 850 143 proposed an articulation system of the aforementioned type that comprises two pivot pieces each having a recessed zone limited by an at least partly curved surface, each of the said pivot pieces belonging respectively to one of the said rigid elements, the said pivot pieces being substantially orthogonal to one another, and engaged in one another by interpenetration of their respective recessed zone in order to be able to pivot relative to one another like the links of a chain.

FR-A-2 850 143 indicates that one of the pivot pieces is advantageously closed (ring, loop, etc.) and the other open (hook) because that may make assembly or disassembly easier.

In reality, however, except if it is indeformable, the hook cannot be left open after assembly and it is necessary to close it by welding, an exacting and time-consuming operation. The result of this is an increase in the cost of the product. In addition, it is not possible to dismantle the articulation without destroying this spot of weld.

The use of a indeformable hook, which can therefore not open under tension, requires, for its part, the use of a sufficiently thick wire, which brings problems both of space requirement and of implementation since, while ending with a indeformable hook in service, the wire must indeed be deformable to allow the hook to be made.

The object of the present invention is to resolve this problem.

For this purpose, it proposes a mechanism that, like FR-A-2 850 143 comprises, on the one hand, a pivot piece in the shape of a hook provided with a rectilinear shank mounted slidingly in a housing belonging to one of the said rigid elements, and, on the other hand, an interacting piece belonging to the other of the said rigid elements, the said pivot piece and the said interacting piece being substantially orthogonal to one another, and the interacting piece being engaged in the recessed zone delimited by the curved portion of the hook, the mechanism however differing from FR-A-2 850 143 in that, at its other end from the said shank, the said curved portion of the hook comprises an extension that is rectilinear and parallel to the said shank and a sheath is suitable for receiving the said extension, the said extension being capable of a movement in translation that is rectilinear and parallel to the said shank, while remaining permanently engaged in the said sheath.

Thanks to this arrangement, it is no longer necessary to produce the hook so that it is indeformable in service or to close the hook with a spot of weld, this closure being achieved by penetration of the rectilinear extension in the sheath provided for this purpose.

In a first embodiment, the sheath consists of a portion of the end of the rigid element in which the said housing is made, the said sheath determining a cavity adjacent to the said housing and capable of receiving the said extension.

This cavity may be a through-hole but, preferably, it is a blind hole for reasons of general strength and appearance.

The rectilinear extension may be locked in place by being forced into the cavity of the sheath. However, in a preferred embodiment, the shank of the hook is forced by elastic means in the direction of insertion of the rectilinear extension, which holds the extension engaged in its sheath.

Additionally and advantageously, the shank of the hook forms a captive tie-rod of the said housing, the said tie-rod interacting with the said elastic means to force the bearing faces of the said rigid elements to remain in contact with one another and, simultaneously, keep the said extension engaged in its sheath.

The geometry of the cross section of the cavity of the sheath corresponds to that of the rectilinear extension and it will usually be circular, but nothing prevents it from being otherwise (square, rectangular, etc.) if the rigid elements are made by moulding.

In a particular embodiment of the invention, the said housing comprises, separated by a partition, a proximal portion in which the said hook is captive and a distal portion, the said sheath determining a cavity of oblong cross section which communicates longitudinally with the proximal portion of the said housing. The rigid element in which the said housing and the said sheath cavity are made is thereby easier to manufacture, these two hollows being able to be machined simultaneously without the need to arrange a thin and delicate partition between them.

In a first embodiment of the invention, forming an articulation, the piece that interacts with the aforementioned pivot piece is likewise a pivot piece having a recessed zone limited by an at least partially curved surface, the said hook being engaged in the said second pivot piece by penetrating into its recessed zone, so that the two pivot pieces may pivot relative to one another like the links of a chain.

Advantageously, the second pivot piece is a ring.

In a second embodiment of the invention, forming a hinge, the said piece that interacts with the hook-shaped pivot piece is a shaft.

In a particular application of the invention, the said rigid elements are respectively a side arm and a face of spectacles.

In another particular application of the invention, the said rigid elements belong to an articulated series for use in robotics.

The invention will now be described with further details with reference to the appended drawings in which:

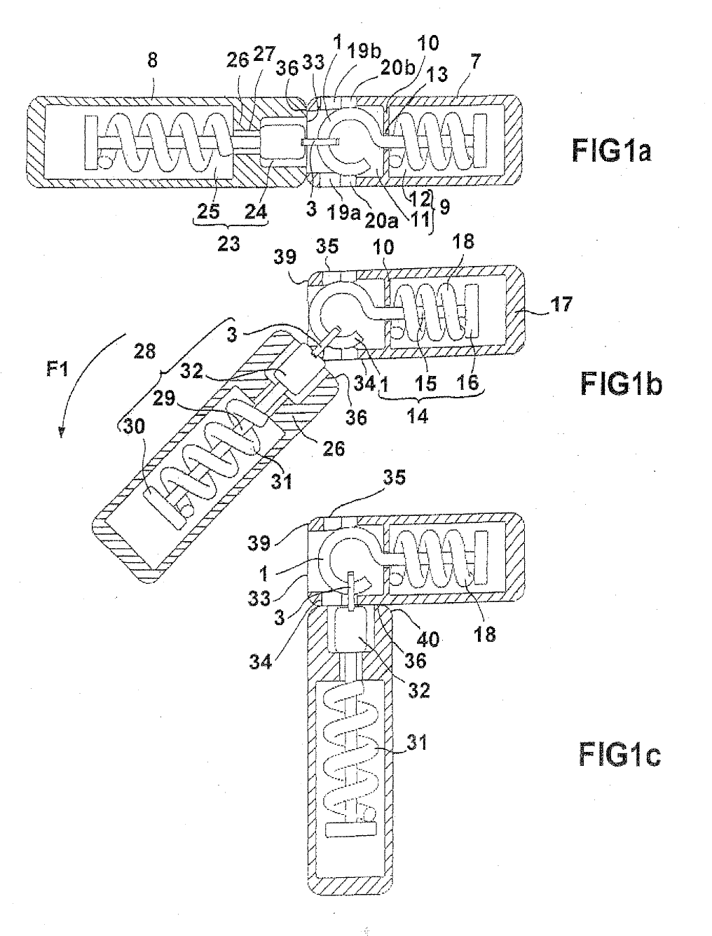

FIGS. 1a to 1c illustrate the prior art according to FR-A-2 850 143;

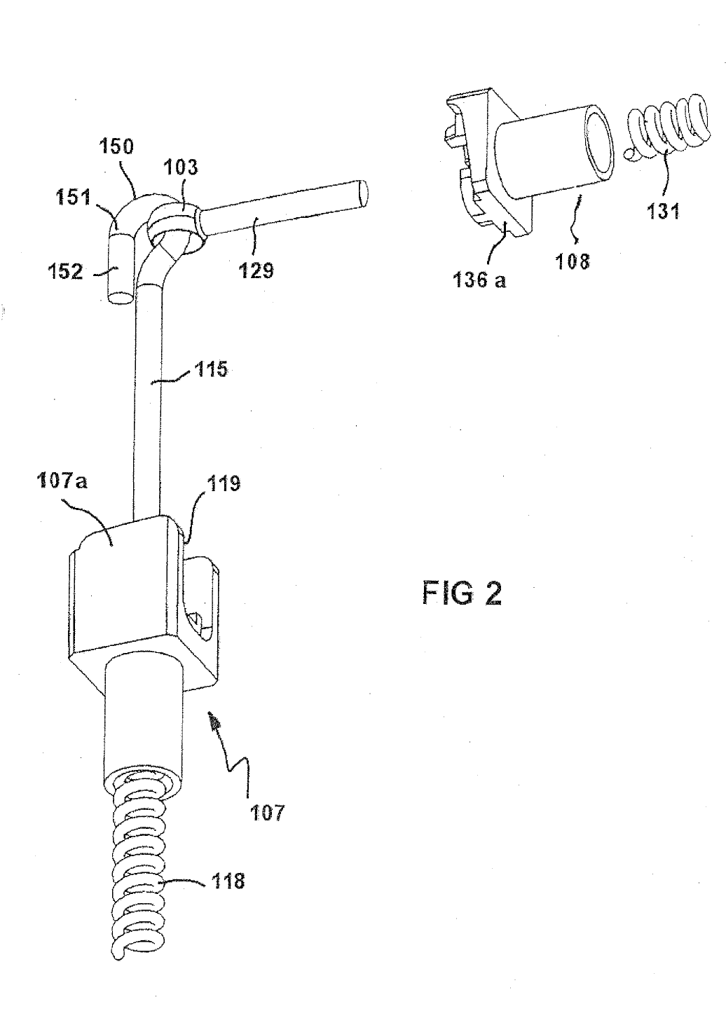

FIG. 2 is a representation of the various component pieces of the mechanism according to the invention, applied to the production of an articulation capable of a 90° disarticulation;

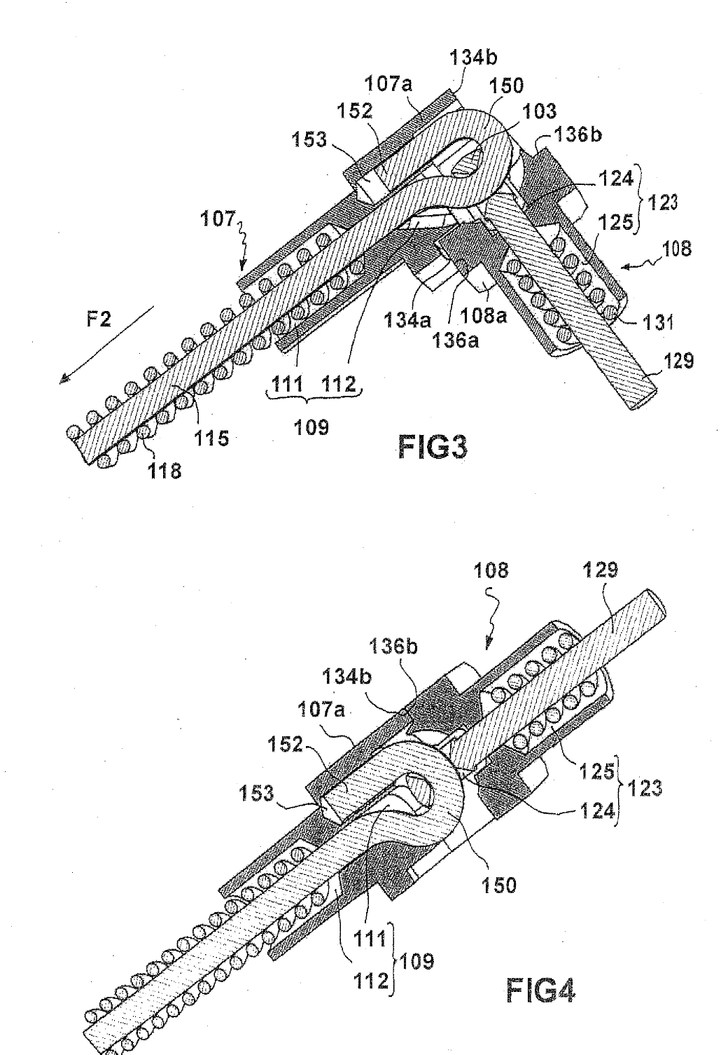

FIG. 3 is a section of the articulation resulting from the assembly of the pieces illustrated in FIG. 2, in a first position;

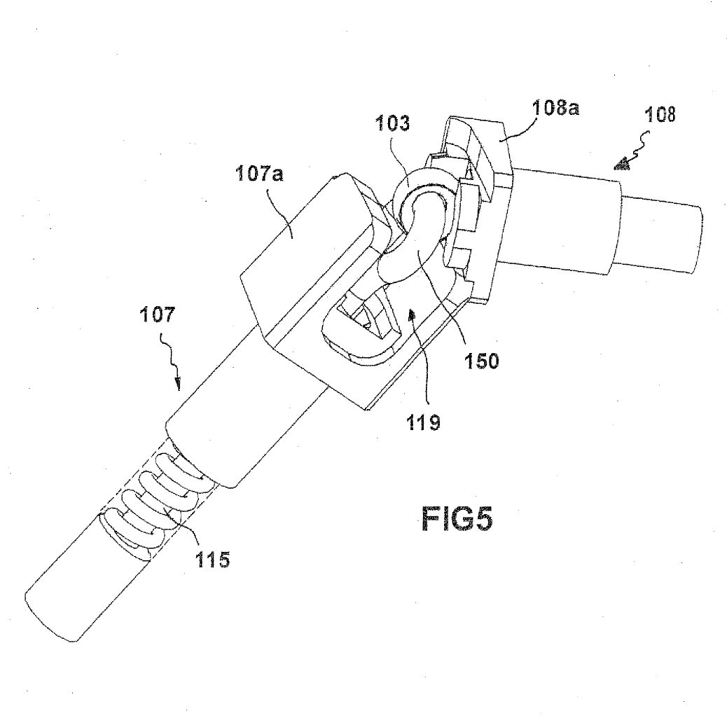

FIG. 4 is a view similar to FIG. 3, but in another position, and with the springs omitted;

FIG. 5 is a view in perspective of the articulation of FIGS. 3 and 4, with a portion of the fixed element omitted to show the spring that it contains;

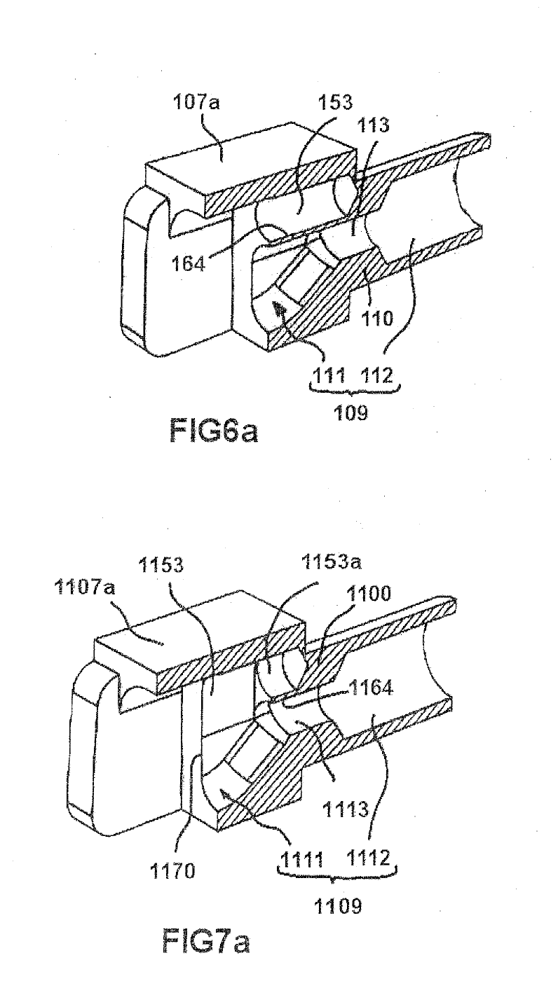

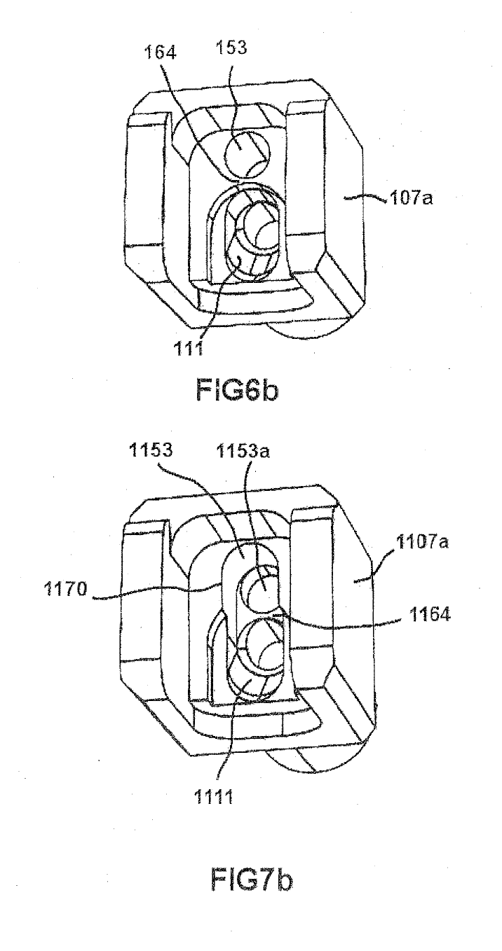

FIGS. 6a and 6b represent respectively, in longitudinal section and in perspective, the end of the fixed element of the embodiment of FIGS. 3 to 5;

FIGS. 7a and 7b represent respectively, in longitudinal section and in perspective, a variant embodiment of the end of the fixed element of the embodiment of FIGS. 3 to 5;

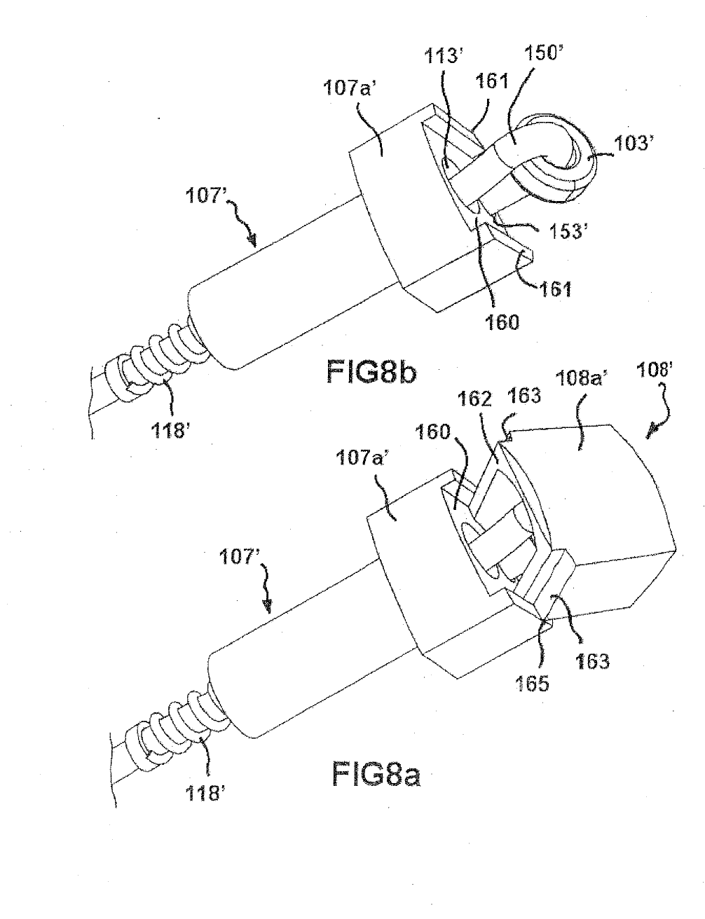

FIG. 8a is a view in perspective of a variant of the mechanism according to the invention, applied to the production of an articulation capable of a 45° disarticulation;

FIG. 8b is a view identical to FIG. 8a but with the housing of the mobile element omitted;

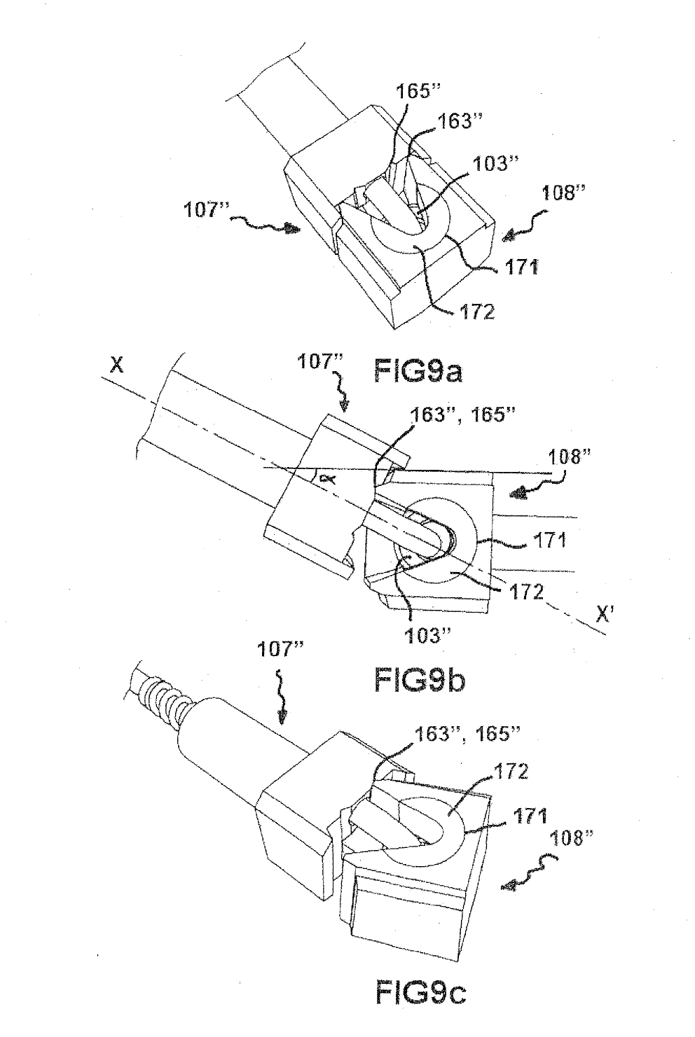

FIGS. 9a-9c are views in perspective of a variant of the mechanism according to the invention, applied to the production of an articulation capable of an approximately 25° disarticulation;

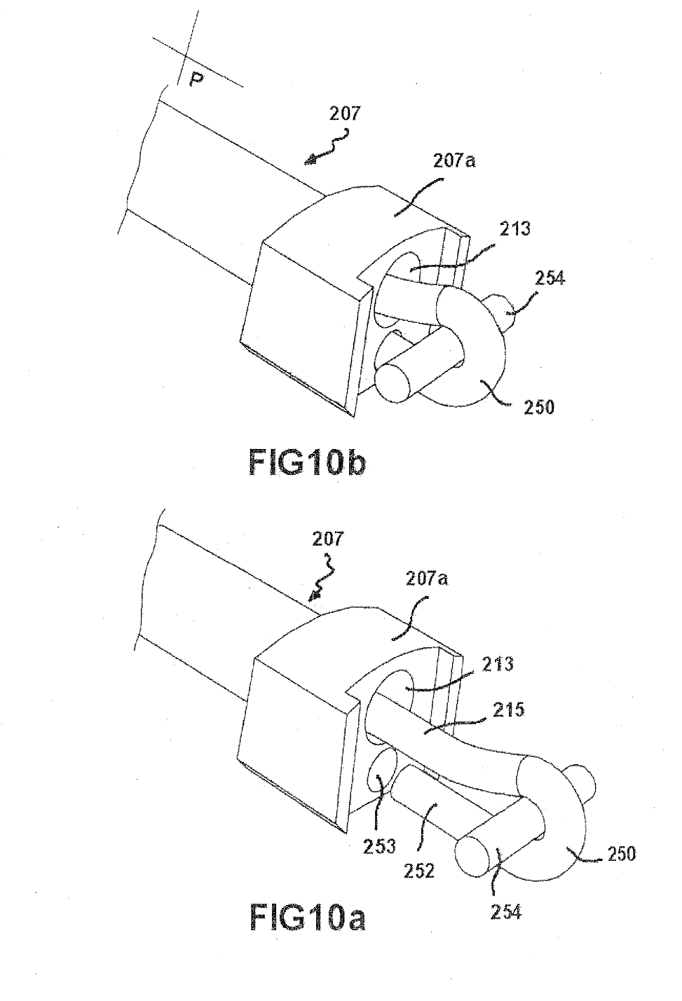

FIGS. 10a and 10b illustrate the application of the invention to a hinge, respectively, during assembly and after assembly, only one of the rigid elements to which the invention is applied being represented for the clarity of the drawing;

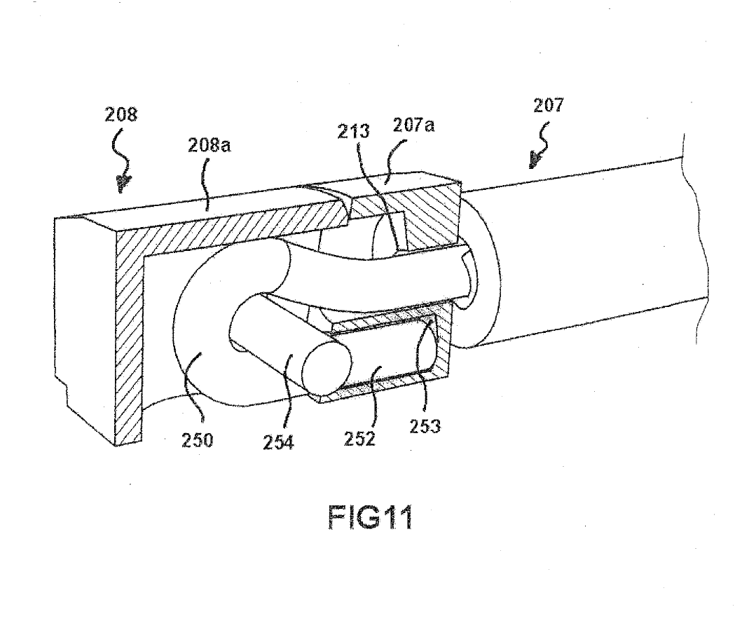

FIG. 11 is a section taken in the axial plane P of FIG. 10b, with representation of a portion of the two rigid elements;

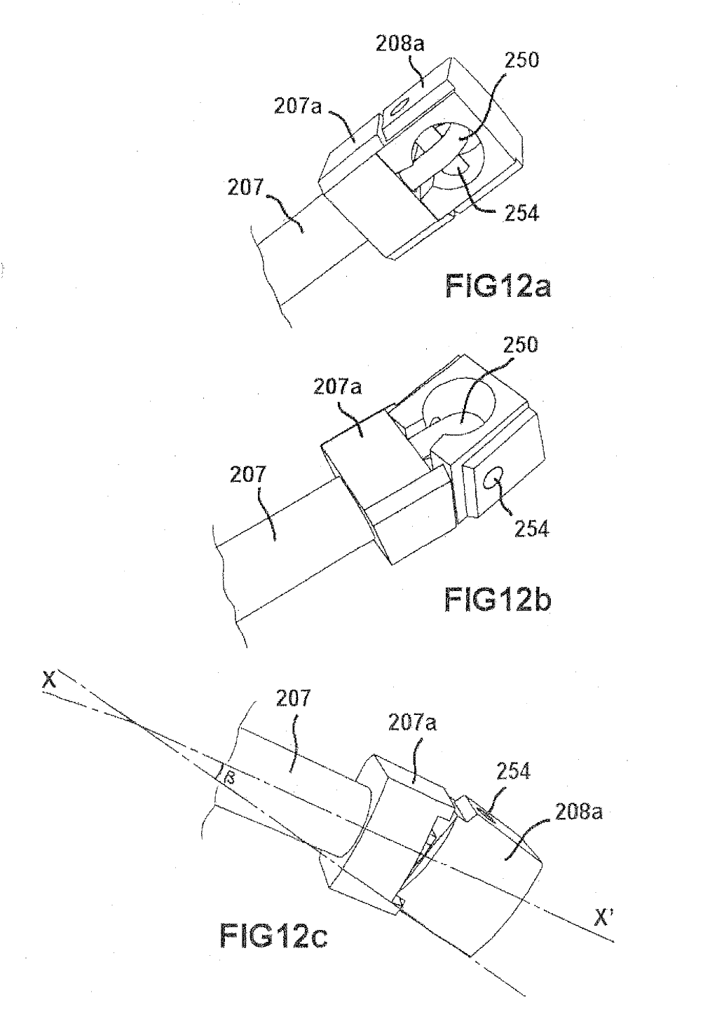

FIGS. 12a-12c represent the zone of the hinge of FIGS. 10a, 10b and 11 in the aligned (FIG. 12a) and dislocated (FIGS. 12b-12c) position, the hinge being capable of a disarticulation of approximately 10°.

FIGS. 1a, 1b and 1c illustrate an articulation of the prior art, relying on the interaction of a hook 1 and a link 3, the said articulation being observed in the plane of the hook 1, respectively in a first stable position, in an unstable position and in a second stable position (for further details, refer to FR-A 2 850 143).

As emerges from these figures, the articulation system of the prior art is mounted partially in a first rigid element 7, called “fixed”, and partially in a second rigid element 8, called “mobile”. It is well understood that this distinction between the “mobile” element and the “fixed” element may be artificial because, in certain cases, each of the elements may be considered to be “mobile” relative to the other.

The fixed element 7 defines a housing 9 divided by a partition 10 into a proximal portion 11 (proximal relative to the articulation) and a distal portion 12. A passage 13 is made in the partition 10 for a tie-rod 14. The tie-rod 14 consists of a stem or shank 15 whose proximal end forms the hook 1 and whose distal end is provided with a stop piece 16. This stop piece 16 may be the head of a screw screwed into the shank 15 of the hook 1, a passage not shown being provided in the bottom 17 of the housing 9 for the insertion of this screw and of the end of a screwdriver. A coil spring 18 is threaded onto the shank 15 which bears, on the one hand, on the stop piece 16 and, on the other hand, on the partition 10. The wall of the proximal portion 11 of the housing 9 has two notches 19a and 19b situated in the plane of the hook 1, each one of which continuing in a ramp 20a and 20b.

The mobile element 8 likewise comprises a housing 23 separated into a proximal portion 24 and a distal portion 25 by a partition 26, in which a passage 27 is made for a tie-rod 28. The tie-rod 28 consists of a stem 29 whose proximal end is secured to a parallelepipedic block 32, forming an anti-rotation member, of dimensions substantially similar to that of the proximal portion 24 of the housing 23 and which is extended by a square plate 3 having a circular hole, the plate hereinafter called the link 3. The distal end of the stem 29 is provided with a stop piece 30 which, like the stop piece 16, may be a screw head. A coil spring 31 is threaded onto the stem 29 and bears, on the one hand, on the stop piece 30, and, on the other hand, on the partition 26.

The proximal end of the fixed element 7 has three bearing faces 33, 34 and 35 and the proximal end of the mobile element 8 has a bearing face 36. The edges 39 and 40 of the proximal end of the fixed element 7 and mobile element 8 are rounded to make the relative movement between the two elements easier.

The tension of the springs is chosen so that, in a stable position, the spring 18 holds the hook 1 back from the bearing face 33 and so that the spring 31 holds the block 32 so that its proximal face is flush with the bearing face 36.

In FIG. 1a, the assembly occupies a first stable position in which the fixed element 7 and mobile element 8 are in alignment with one another, the bearing face 36 of the mobile element 8 being pressed against the bearing face 33 of the fixed element. In this position, the hook 1 is set back relative to the bearing face 33 and the link 3 is received in the proximal portion 11 of the housing 9 of the fixed element 7.

In FIG. 1b, the mobile element 8 has been “dislocated” relative to the position that it occupied in FIG. 1a to be able to pivot according to the arrow F1. This dislocation is made possible by a tension exerted by the link 3 on the hook 1, against the force of the springs 18 and 31 which are thereby compressed. It can be seen that the hook 1 is now level with the bearing face 33 and that the block 32 protrudes slightly from the mobile element 8. The pivoting action is also made possible by the presence of the notch 19a which allows the link 3 and the block 32 to pass.

In FIG. 1c, the bearing face 36 of the mobile element 8 is now pressed against the bearing face 34 of the fixed element 7. The hook 1 and the block 32 have resumed their positions of FIG. 1a and the springs 18 and 31 have also returned to their initial degree of tension. The link 3 is in contact with the ramp 20a via its invisible section, while its visible section is in contact with another ramp, not visible, symmetrical to the ramp 20a.

It is understood that, the fixed element 7 comprising a second notch 19b opposite the notch 19a, the mobile element 8 could be brought into a third stable position, that is with its bearing face 36 pressed against the bearing face 35 of the fixed element 7.

Although, in FIGS. 1a-1c, the hook 1 is shown open, in practice, once threaded into the link 3, it must be closed by a spot of weld, a tricky operation because of the very small dimension of the pieces concerned and which increases the labour cost. If it is not welded, the hook must be made so as to be indeformable, with the problems of space requirement and implementation mentioned hereinabove.

This problem is solved by the invention, as emerges from FIGS. 2 to 5 where the pieces identical or similar to pieces already described with reference to FIGS. 1a-1c are identified by the same reference number increased by 100.

FIG. 2 again shows the fixed element 107, the mobile element 108, the coil springs 118 and 131 and the shank 115 of the tie-rod fitted to the fixed element 107. The articulation according to the invention differs however from the articulation of the prior art in the configuration of the hook 150 whose end 151 at the other end from the shank 115 comprises an extension 152 parallel to the said shank.

As appears furthermore from FIGS. 3 and 4 (where the tie-rod 129 of the mobile element is also shown and where the housings 109 and 123 can be seen), the end 107a of the fixed element 107 in which the distal portion 111 of the housing 109 is made comprises a blind hole 153 in which the extension 152 is received. Since the spring 118 (FIG. 3) permanently forces the assembly 115, 150, 152 in the direction of the arrow F2, the extension 152, once engaged in the blind hole 153, remains therein, it however being understood that it may be inserted therein to a greater or lesser degree depending on the force exerted on the hook 150 in the direction contrary to the arrow F2. The length of the blind hole 153 and that of the extension 152 must, obviously, take account of the sliding of the assembly 115, 150, 152 in the fixed element 107 so that, at any time, and irrespective of the respective positions of the rigid elements 107 and 108, the extension 152 is engaged in the blind hole 153.

The engagement of the extension 152 in the blind hole 153 clearly prevents the hook 150 from rotating.

As emerges in particular from FIG. 2, the end 107a has a notch 119 to allow the passage of the ring 103 when the element 108 is dislocated at 90° relative to the element 107 (FIG. 3). FIG. 3 also shows that, in this position, the bearing face 136a of the end 108a of the mobile element 108 butts against the bearing face 134a of the end 107a of the fixed element 107.

Unlike the embodiment of the articulation of the prior art illustrated in FIGS. 1a-1c, in the embodiment of FIGS. 2 to 5, the mobile element 108 cannot adopt a 90° dislocated position symmetrical to that which it has in FIG. 3. The reason for this is that it is prevented therefrom by the bearing face 136b of the end 108a butting against the bearing face 134b of the end 107a.

That apart, with reference to the possible positions of the articulation, the invention does not differ from the prior art:
in FIG. 3, a first stable position is shown that corresponds to that of FIG. 1c of the prior art,
in FIG. 4, a second stable position is shown that corresponds to that of FIG. 1a of the prior art, and
in FIG. 5, an unstable intermediate position is shown, that corresponds to that of FIG. 1b of the prior art.

FIGS. 6a and 6b show in detail the structure of the end 107a of the fixed element 107 suitable to be matched with the end 108a of the mobile element 108.

A passage 113 is again found equivalent to the passage 13 FIGS. 1a-1c made in a partition 110 dividing the housing 109 into a proximal portion 111 and a distal portion 112. It can be seen that the cylindrical blind hole 153 forming a sheath is separated by a partition 164, on the one hand, from the proximal portion 111 of the housing suitable for receiving the hook 150 and, on the other hand, from the passage 113.

However in a variant embodiment, represented in FIGS. 7a and 7b, the cavity 1153 of the sheath and the proximal portion 1111 of the housing 1109 communicate along their whole length, and there remains only a fraction of partition 1164 at the passage 1113. As can be seen, the common entrance 1170 to the cavity 1153 and to the proximal portion 1111 of the housing 1109 is oblong in order to retain the antirotation function of the said cavity of which the only circular section that remains is the end 1153a.

Coming to FIGS. 8a and 8b, these show a variant embodiment of the articulation according to the invention where the identical or similar pieces to the pieces already described with reference to FIGS. 2 to 5 are identified by the same reference number followed by the prime sign.

This variant differs from the preceding articulation only in the configuration of the free faces of the ends of 107a′ and 108a′. As can be seen, the free face 160 of the end 107a′ has two parallel protruding borders 161 between which the free face 162 of the said end 108a′ may come to be housed. On either side of the end face 162, the end 108a′ defines two shoulders 163 coming to press on the top face of the borders 161 when the elements 107′ and 108′ are aligned and whose end 165 butts against the said top face when the element 108′ is made to pivot, thus limiting the disarticulation to 45°

FIGS. 9a-9c represent a variant embodiment in which the pieces that are identical or similar to pieces already described with reference to FIGS. 2 to 5 are identified by the same reference number followed by the double point sign. The variant of FIGS. 9a-9c allows a pivoting movement through an angle α of approximately 25° either side of the axis X-X′, this pivoting movement being limited by the mobile element 108″ coming to a protruding abutment 163″ in the grooves 165″ made in the fixed element 107″.

In this embodiment, the mobile element 108″ has a cylindrical cut-out 171 suitable for receiving a plug 172 which comes to immobilize the ring 103″ in the mobile element 108″.

Now turning to FIG. 10a and following, these illustrate the application of the invention to a hinge in which the pieces identical or similar to pieces already described with reference to FIGS. 1a-1c or 2 to 5 are identified by the same reference number increased by 200.

FIG. 10a shows the fixed element 207 whose end 207a comprises a passage 213 for the shank 215 of the hook 250 and a blind hole 253 suitable for receiving the extension 252 of the hook 250, the passage and blind hole which are more clearly visible in FIG. 11 which also represents the mobile element 208. Unlike the embodiment shown in FIGS. 2 to 5, the hook 250 is not engaged with a ring but with a shaft 254.

Such a configuration allows a disarticulation through an angle β of the order of 15° (see FIGS. 12a-12c) either side of the axis X-X′. It is well understood that the invention is not limited to the embodiments described and shown. Therefore, in particular, the embodiment of the sheath illustrated in FIGS. 7a-7b with reference to an articulation could equally well be applied to a hinge.

1-10. (canceled)

11. Mechanism allowing a relative pivoting movement between an end of a first rigid element and an end of a second rigid element, the ends having bearing surfaces capable of matching respectively with one another, elastic means being provided to maintain the contact between the surfaces, the mechanism comprising, a pivot piece in the shape of a hook provided with a rectilinear shank mounted slidingly in a housing belonging to one of the rigid elements, and, an interacting piece belonging to the other of the rigid elements, the pivot piece and the interacting piece being substantially orthogonal to one another, and the interacting piece being engaged in the recessed zone delimited by the curved portion of the hook, wherein, at its other end from the shank, the curved portion of the hook comprises an extension that is rectilinear and parallel to the shank and wherein a sheath is suitable for receiving the extension; said extension being capable of a movement in translation that is rectilinear and parallel to the shank, while remaining permanently engaged in the sheath.

12. Mechanism according to claim 11, wherein the sheath consists of a portion of the end of the rigid element in which the housing is made, the sheath determining a cavity adjacent to the said housing and capable of receiving the extension.

13. Mechanism according to claim 11, wherein the sheath consists of a portion of the end of the rigid element in which the housing is made, the sheath determining a blind hole forming a cavity adjacent to the housing and capable of receiving the extension.

14. Mechanism according to claim 12, wherein the cross section of the cavity is circular.

15. Mechanism according to claim 11, wherein the housing comprises, separated by a partition, a proximal portion in which the hook is captive and a distal portion, and the sheath determines a cavity of oblong cross section which communicates longitudinally with the proximal portion of the housing.

16. Mechanism according to claim 11, wherein the interacting piece is a second pivot piece having a recessed zone limited by an at least partially curved surface, the hook being engaged in the second pivot piece by penetrating into its recessed zone, so that the two pivot pieces may pivot relative to one another like the links of a chain.

17. Mechanism according to claim 11, wherein the interacting piece is a ring having a recessed zone limited by an at least partially curved surface, the hook being engaged in the second pivot piece by penetrating into its recessed zone, so that the two pivot pieces may pivot relative to one another like the links of a chain.

18. Mechanism according to claim 11, wherein the interacting piece is a shaft.

19. Mechanism according to claim 11, wherein the rigid elements are respectively a side arm of spectacles and a face of spectacles.

20. Mechanism according to claim 11, wherein the rigid elements belong to an articulated series for use in robotics.

21. Mechanism according to claim 13, wherein the cross section of the cavity is circular.
